(19) United States
(12) Patent Application Publication
(10) Pub. No.: US 2011/0099095 A1
(43) Pub. Date: Apr. 28, 2011

(54) PROCESSING INTERNAL USE OF DATA-CENTER RESOURCES

(75) Inventors: GEORGE M. MOORE, ISSAQUAH, WA (US); AKRAM M.H. HASSAN, ISSAQUAH, WA (US); DIANNE DENISE O'BRIEN, CLINTON, WA (US)

(73) Assignee: MICROSOFT CORPORATION, REDMOND, WA (US)

(21) Appl. No.: 12/607,797

(22) Filed: Oct. 28, 2009

(51) Int. Cl. G06Q 10/00; G06Q 30/00; G07F 19/00; G06F 17/00; G07B 17/00

(52) U.S. Cl. 705/30; 705/7.11; 705/400

(57) ABSTRACT

Internal use of an entity's data center is processed on a sub-entity basis. A sub-entity's consumption of a data-center resource is tracked and pricing information is applied to a quantity of the data-center resource that is consumed to determine an amount to be charged to the sub-entity. An accounting application of the entity is accessed to perform a charge back from the sub-entity. The accounting application reports the amount as an internal cost transfer of the entity.

### BACKGROUND

A typical data center includes a collection of computing components that are usable to perform various computing functions. Often, an entity, such as a business enterprise, will own and manage its own private data center, the resources of which are dedicated to execution of the entity's applications. For example, an entity might prefer to retain control over data-center resources that are used to house highly valuable business data or other sensitive information.

Acquiring and managing data-center components requires both an up-front investment of capital, as well as, ongoing payment of expenses. Exemplary up-front expenses include equipment and installation costs. Exemplary ongoing expenses arise from power requirements, maintenance, and personnel (e.g., IT Department).

Generally, the resources of an internal data center (e.g., CPU, bandwidth, storage, etc.) are shared by various sub-entities of the entity that owns the data center. For example, a business enterprise might include a marketing department, a research and development department, and a human resources department, all of which utilize the resources of the business enterprise's data center.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section. This summary is not intended to identify key features or essential features of the claimed subject matter, nor is it intended to be used as an aid in isolation to determine the scope of the claimed subject matter.

In one embodiment, the present technology includes an integrated solution that processes (e.g., prices, bills, and reports) internal use of an entity's data center. An exemplary method includes tracking a sub-entity's consumption of a data-center resource. Pricing information is applied to a quantity of the data-center resource that is consumed to determine an amount to be charged to the sub-entity. An accounting application of the entity is accessed to perform a charge back from the sub-entity. The accounting application reports the amount as an internal cost or expense transfer of the entity.

### BRIEF DESCRIPTION OF THE DRAWINGS

Illustrative embodiments of the present invention are described in detail below with reference to the attached drawing figures, wherein:

FIG. 1 depicts an exemplary operating environment in accordance with an embodiment of the present invention;

FIG. 2 depicts an exemplary system in which embodiments of the invention might be employed; and

FIGS. 3 and 4 each depict a respective exemplary method for processing internal use of an entity's data center, in accordance with an embodiment of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated.

Generally, the present invention is directed to an integrated solution that processes internal use of an entity's data center. For example, the solution prices, bills, and reports internal use of a data center on a sub-entity basis. As such, one embodiment includes a method of processing internal use of an entity's data center by a sub-entity. The method includes tracking a consumption of a quantity of a data-center resource. The quantity of the data-center resource is consumed in order to execute a computing or storage or bandwidth operation of the sub-entity. Moreover, pricing information is applied to the quantity to determine an amount to be charged to the sub-entity. The method further includes interfacing by a computing device with an accounting application of the entity to perform a charge back from the sub-entity that is equal to the amount. The accounting application reports the amount as an internal cost or expense transfer of the entity.

A further embodiment of the present invention includes a system, which includes a server, a processor, and a computer-readable medium, for performing a method of processing internal use of an entity's data center by a sub-entity of the entity. The system includes the computer-readable medium having stored thereon data of the sub-entity that facilitates a computing operation, wherein execution of the computing operation consumes a quantity of a data-center resource. The system also includes a resource-consumption tracker that measures the quantity of the data-center resource that is consumed by execution of the computing operation. Moreover, the system includes a charge generator that applies a pricing model to the quantity to determine an amount to be charged to the sub-entity and a billing device driver that interfaces with an accounting application of the entity to perform a charge back from the sub-entity that is equal to the amount.

Another embodiment of the present invention includes one or more computer-readable media having computer-executable instructions embodied thereon that, when executed by a computing device, cause the computing device to perform a method of reporting internal use of an entity's data center by a sub-entity of the entity. The method includes receiving account information that is usable to establish an account of a first sub-entity. The account associates the first sub-entity with the data center. Pricing rules are stored in a billing engine and are to be applied to consumption of a data-center resource that is attributable to the account. The method further includes receiving a first verification that an application of the first sub-entity complies with a policy of the entity and a second verification that a method of payment has been established to be utilized when the data-center resource is consumed. The method still further includes tracking a consumption of a quantity of the data-center resource. The quantity of the data-center resource is consumed in order to execute a computing operation of the sub-entity. The pricing rules are referenced in the billing engine to determine an amount to be charged to the first sub-entity in exchange for execution of the application. Moreover, the method includes interfacing with an accounting application of the entity to perform a charge back from the first sub-entity that is equal to the amount. The charge back transfers the amount from the first sub-entity to a second sub-entity of the entity, and the accounting application reports the amount as an internal cost or expense transfer of the entity.

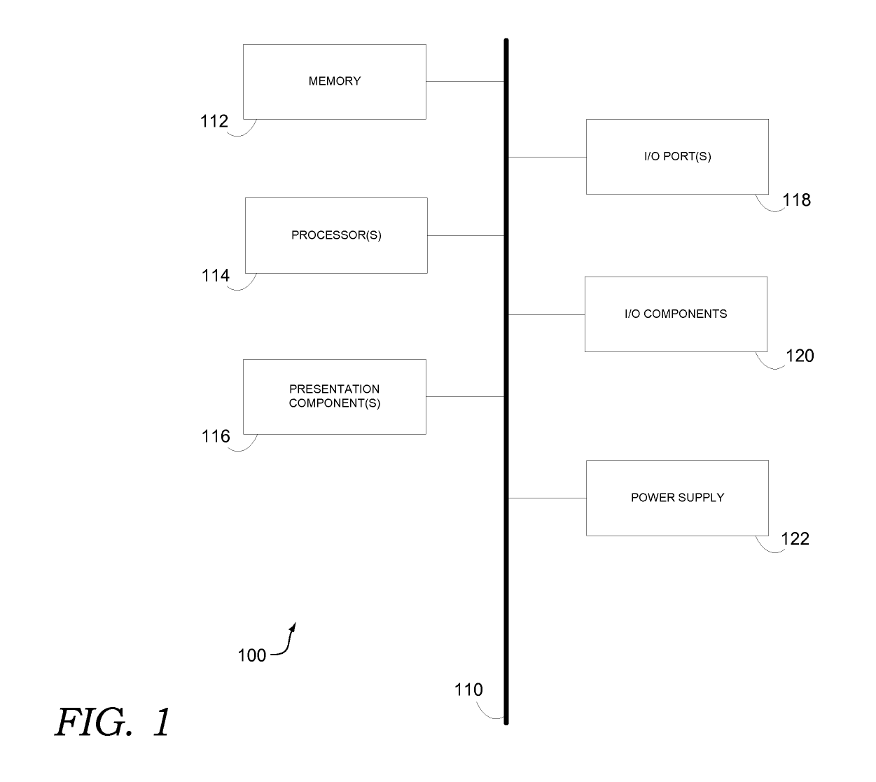

Having briefly described a few embodiments of the present invention, an exemplary operating environment suitable for implementing embodiments of the present invention is now described with respect to FIG. 1. FIG. 1 depicts an exemplary operating environment, which is shown and designated generally as computing device 100. Computing device 100 is but one example of a suitable computing environment and is not intended to suggest any limitation as to the scope of use or functionality of invention embodiments. Neither should the computing-environment 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. Computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media includes wired media such as a wired network or direct-wired connection, and wireless media such as acoustic, RF, infrared and other wireless media. Combinations of any of the above should also be included within the scope of computer-readable media.

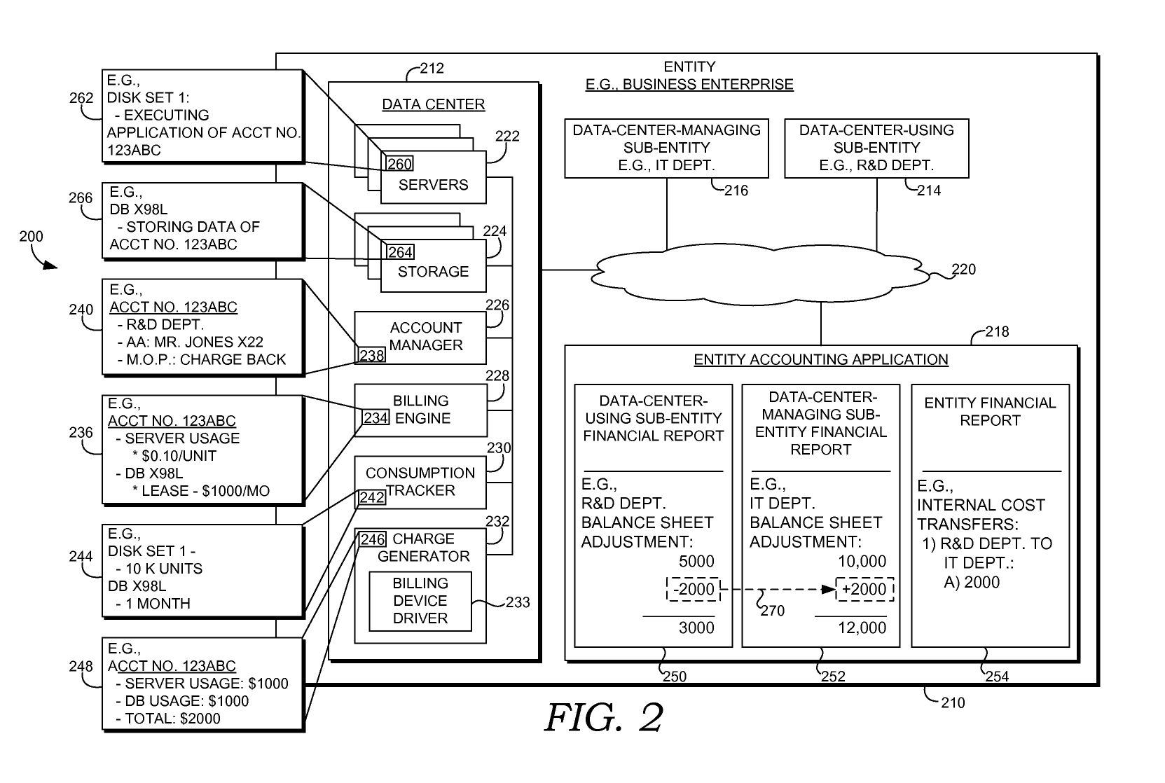

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. For example, processors 114 might read data from memory 112 that provides computer-executable instructions of an entity accounting application (e.g., entity accounting application 218 of FIG. 2) or of a charge generator (e.g., charge generator 232 of FIG. 2).

I/O ports 118 allow computing device 100 to be logically coupled to other devices including I/O components 120, some of which may be built in. Illustrative components include a microphone, joystick, game pad, satellite dish, scanner, printer, wireless device, etc.

Referring now to FIG. 2, a schematic diagram depicts an operating environment, identified generally by reference numeral 200, that is suitable to practice an embodiment of the present invention. FIG. 2 includes various components that communicate with one another to process internal use of an entity's data center. FIG. 2 depicts an entity 210 that encompasses various other elements, including a data center 212, a data-center-using sub-entity 214 (also referred to herein as “DC-using sub-entity 214” or simply “sub-entity 214”), a data-center-managing sub-entity 216 (also referred to herein as “DC-managing sub-entity 216” or simply “sub-entity 216)), and an entity accounting application 218. A network 220 facilitates communication between various elements of FIG. 2.

In an embodiment of the invention, entity 210 is an organization that is comprised of sub-entities and that uses an internal data center (e.g., a data center that is either directly or indirectly owned by the entity). For example, entity 210 might be a business enterprise that includes a research and development department and an information-technology department. Moreover, an internal data center of entity 210 might be used to deploy cloud applications of the entity (i.e., private-cloud applications). In a further embodiment of the present invention, entity 210 leverages an accounting application to facilitate budgeting and financial reporting.

In another embodiment of the invention, entity 210 utilizes data center 212 to execute applications of entity 210 and sub-entities of entity 210. For example, entity 210 might have purchased equipment of data center 212 and paid to have data center 212 constructed or otherwise assembled. Alternatively, data center 212 might include a modular data center purchased by entity 210 that includes a pre-fabricated shipping container having the necessary components of a functional data center, such as servers, power sources, I/O components, and HVAC.

In FIG. 2, data center 212 includes various components, including servers 222, storage 224, an account manager 226, a billing engine 228, a data-center-resource consumption tracker 230, and a charge generator 232, each of which are now briefly described. Both servers 222 and storage 224 are usable to execute computer operations. For example, servers 222 might be used to execute applications of entity 210, such as private-cloud applications of the sub-entities of entity 210. In general, the term “cloud computing” refers to a virtualization of interchangeable components (e.g., servers, storage, and network) to be managed as a single fabric. As such, a “cloud application” is generally an application that leverages and is deployed on the resources of data center 212 (i.e., the cloud), as opposed to being deployed on an independent set of resources. An example of a private-cloud application includes a development and test environment, established within data center 212, that is accessible by a developer to quickly provision resources to develop and test a new application or piece of code.

Servers 22 might be physical, virtual, or any combination thereof. Storage 224 stores data of entity 210, such as data of sub-entities of entity 210. Account manager 226 is used to establish and maintain accounts of entity 210 and of sub-entities of entity 210. Such accounts allow a relationship to be established with data center 212. Billing engine 228 stores pricing information (e.g., pricing models and pricing sheets) that is applied to use of data-center resources (e.g., bandwidth). Consumption tracker 230 tracks consumption of data-center resources, such as server and storage use. Charge generator 232 calculates charges to be applied to an account by applying pricing information to a quantity of used data-center resources. Charge generator 232 includes billing device driver 233, which includes a device driver that is customized to interface with an accounting application of entity 210. These components of data center 212 will be described in more detail below.

In a further embodiment of the present invention, entity 210 is comprised of a data-center-managing sub-entity 216 and a data-center-using sub-entity 214. Data-center-managing sub-entity 216 is a sub-entity of entity 210 that is responsible for managing and maintaining data center 212. For example, data-center-managing sub-entity might be an information-technology department, a/k/a IT Department. Data-center-using sub-entity 214 is a sub-entity of entity 210 that uses data-center resources, such as to execute computer applications. For example, data-center-using sub-entity 214 might include a research and development department of entity 210 that uses storage 224 to store sensitive data. FIG. 2 depicts that all of data center 212, data-center-managing sub-entity 216, and data-center-using sub-entity 214 are in communication with one another by way of network 220.

In another embodiment of the present invention, entity accounting application 218 facilitates budgeting and reporting of entity 210. For example, entity accounting application 218 might be used to account for respective revenues and expenses of entity 210 and of sub-entities 214 and 216. Moreover, entity accounting application 218 might be used to generate respective financial reports of entity 210 and sub-entities 214 and 216.

Having briefly described various elements depicted in FIG. 2, further embodiments of the present invention now are described in more detail. Often, entity 210 desires oversight of sub-entity use of data center 212. Such oversight is desirable to ensure compliance with policies of entity 210, as well as, to monitor usage of data-center resources. For example, entity 210 might not want an application to be executed by servers 222 if the application presents security risks to entity 210. Further, if entity 210 has established an internal budget, which apportions to data-center-using sub-entity 214 a cap of budgeted funds to be applied towards use of data-center resources, entity 210 might want to know if that cap has been exceeded. An embodiment of the present invention enables such oversight.

For purposes of the present invention, it is assumed that entity 210 includes a form of internal IT security and compliance process, which is defined to vet entity employees (e.g., employees that work under sub-entity 214) who wish to use data-center resources to host an application, e.g., a private-cloud application. It is further assumed that once the internal vetting process is completed, a properly authorized IT administrator (e.g., personnel under sub-entity 216) has a set of special privileges by which to authorize an internal employee who can then deploy and manage a cloud application. In an embodiment of the present invention, this step of authorizing requires establishing an account, establishing pricing rules, verifying compliance with entity policies, and establishing a billing relationship that facilitates payment for use of data-center resources.

In an embodiment of the present invention, a properly authorized IT administrator is initially bootstrapped to enable entity accounts. For example, storage account keys might be utilized that correspond to a primary user-account store within an operating system of data center 210. In one embodiment direct read/write access to this storage account is possible. Alternatively, access to the storage account is via a special set of admin APIs, which are keyed to a specific set of directory service account (e.g., Active Directory accounts), which are established during an initial deployment of the data-center operating system. These admin APIs provide the facilities to mark specific subservient directory-service employee accounts as “enabled” for internal deployments and for internal billing operations.

In a further embodiment of the present invention, data-center-managing sub-entity 216 establishes an internal “pricing sheet” that is applicable to internal use of data-center resources by DC-using sub-entity 214. The pricing sheet comprises a set of internal-only offers, which are not available to public (non-internal) use of similar data-center resources. An embodiment of the present invention allows for customization, as well as updating, of an internal pricing sheet that is applicable to an account of a sub-entity. For example, the internal pricing sheet might contain a per-resource metered price for use of data-center resources by sub-entities of entity 210, such that an internal sub-entity can choose to pay for exactly the resources that they consume. Moreover, the internal pricing sheet might include differential pricing based on geographic region and degrees of physical security associated across a potentially multinational enterprise. For example, higher costs might be associated with a heavily guarded data center in a remote location, thereby justifying higher prices. Differential pricing might also be applied when an internal entity wishes to commit to paying for use of an ordered amount of resources. In this respect, lower costs might be associated with knowing in advance, exactly how much capacity is going to be required. Such pricing flexibility allows data-center-managing sub-entity 216 to customize, and update as needed, pricing sheets based on various factors, such as cost structure of entity 210, IT overhead, and physical cost to deploy data center 210 with an operating system. Once a pricing sheet is established, an embodiment of the present invention enables data-center-managing sub-entity 216 to enter the pricing sheet into billing engine 228. For example, billing engine 228 includes data 234, which is shown in an exploded view 236 for illustrative purposes. Exploded view 236 shows an example of pricing sheet details, in which a portion of a database is leased for $1000/mo and server usage is priced at $0.10 per unit. For example, storage might be priced at $0.05 GB/month, such that a lease of $1000/mo provides for 20,000 GB of storage per month. Moreover, a unit of server usage might be defined by units of time or by units (e.g., GB) of data transferred in and out.

Another embodiment of the present invention allows the now-bootstrapped IT administrator to uniquely target a specific account. For example, a special internal-only flag might be set per employee account by the IT administrator. In one embodiment, the flag is a multi-part flag that can give varying degrees of access to different operating-system clusters, each with perhaps different permissions or geographic distributions. Access might be determined based on various factors, such as a security review, a privacy review, an efficiency review, and a budget review. In one embodiment, a security review determines the ease or difficulty with which code, which a sub-entity is requesting to execute using data-center resources, might be hacked and altered. In another embodiment, a privacy review determines an extent to which data is available for unauthorized disclosure. In a further embodiment, an efficiency review measures the resources required to execute an application of a sub-entity. A budget review determines whether a sub-entity has funds that are budgeted to pay for use of data-center resources. Based on any one of, or a combination of, these reviews, an account can be uniquely flagged to allow a certain degree of access to data-center resources. For example, if based on a privacy review a determination is made that data to be utilized by an account is highly sensitive, the account might be blocked from access to data-center resources that are not appropriately certified to store highly sensitive data. Another example includes where a budget review reveals that an account only possesses a limited amount of funds to pay for data-center resources, in which case the functionality of applications of the account is limited or restricted. In a further example, a type of content might not be allowed to be hosted based on statutes or other governing principles, such that one type of flagging includes a legal overlay.

In a further embodiment of the present invention, a billing relationship is established between data-center-using sub-entity 214 and data-center-managing sub-entity 216. One exemplary billing relationship includes a charge back system, whereby funds are internally transferred from DC-using sub-entity 214 to DC-managing sub-entity 216. In an embodiment, establishing a billing relationship allows authorization of multiple sub-entity employees to request the use of data-center resources under a same account.

In an embodiment, account information is maintained by account manager 226. For example, account manager 236 includes data 238, which is shown in an exploded view 240 for illustrative purposes. Exploded view 240 includes information that depicts exemplary details of “Account No. 123abc,” which is assigned to the R&D Department (an exemplary sub-entity of entity 210). Exploded view 240 depicts that an account administrator is “Mr. Jones” and that a charge-back plan has been established to pay for charges arising from use of data-center resources attributable to Account No. 123abc.

These described setup steps that create accounts with customized access, establish pricing rules, and establish billing relationships might be carried out using various techniques. In one embodiment of the present invention, a user interface enables a user of DC-using sub-entity 214 to submit and view information throughout the setup process, such as by using an internal IT-Department landing page. A user interface is also available to an administrator of DC-managing sub-entity 216 to facilitate the setup process.

Once DC-using sub-entity 214 has been vetted and approved, and a payment instrument has been set up, sub-entity 214 is enabled to begin using data-center resources (e.g., servers 222 and storage 224). In an embodiment of the present invention, data center 212 includes data of the sub-entity that facilitates a computing operation, and execution of the computing operation consumes a quantity of a data-center resource (e.g., storage, processing, bandwidth, or a combination thereof). For example, servers 222 include a portion 260, which is shown in an exploded view 262 for illustrative purposes. Exploded view 262 depicts that Disk Set 1 of servers 222 is being used to execute an application (e.g., computer program) associated with Account No. 123abc. As a further example, storage 224 includes a portion 264, which is shown in an exploded view 266. Exploded view 266 depicts that database X98L is storing data of Account No. 123abc. In the course of use by sub-entity 214, such as by execution of an application of sub-entity 214, various consumption metrics are generated by subsystems of data center 212. Examples of consumption metrics include CPU hours, bandwidth, storage capacity, and storage transactions. In an embodiment of the present invention, each of these metrics are gathered on a scheduled basis (e.g., hourly, daily, weekly, etc.). For example, consumption tracker 230 functions to track and log consumption metrics. FIG. 2 depicts that consumption tracker 230 includes data 242, which is shown in an exploded view 244 for illustrative purposes. Exploded view 244 includes exemplary consumption metrics generated from use of servers 222 and storage 224. For example, exploded view 244 depicts that 10K units have been consumed in Disk Set 1 and that DB X98L has been in use for 1 month.

In a further embodiment, gathered consumption metrics are sent to a billing aggregation system of data center 210 that includes charge generator 232. Charge generator 232 processes consumption metrics by applying pricing rules stored in billing engine 228. For example, FIG. 2 depicts that charge generator 232 includes information 246, which is shown in exploded view 248 for illustrative purposes. Exploded view 248 illustrates charges that result from applying pricing rules depicted in exploded view 236 (i.e., $0.10 per unit and DB Lease of $1000/mo) to gathered consumption metrics shown in exploded view 244 (i.e., 10K units and 1 month). As such, exemplary charges in exploded view 248 include $1000 for server usage and $1000 for storage. Once processed, billing records (e.g., hourly billing records, daily billing records, etc.) are available for viewing by a properly authorized billing owner, such as a budgetary owner within a specific sub-entity (e.g., “AA: Mr. Jones”). Moreover, the billing records are also available for viewing, downloading, and business intelligence reporting to DC-managing sub-entity 216.

Once a charge has been determined by charge generator 232, charge generator 232 interacts with entity accounting application 218. In an embodiment of the present invention, charge generator 232 includes billing device driver 233, which enables interfacing with entity accounting application 218. Charge generator 232 might include a plurality of billing device drivers, each customized to interface with a specific type or brand of entity accounting application. In this respect, data center 212 is pre-equipped to interface with a variety of accounting applications, thereby allowing data center 212 to integrate with an entity's existing accounting software without having to interface in an ad hoc manner. That is, absent the billing device driver 233, the internal data center would have to customize interaction with accounting software on a case-by-case basis. Billing device driver 233 provides a variety of pre-configured methods to communicate with an entity's accounting software, such that the billing device driver does not need to be customized by an internal data center in order to implement the present invention.

In one embodiment of the present invention, DC-using sub-entity 214 is charged for all data-center resources used and services rendered over a scheduled period (e.g., every month) that are attributable to DC-using sub-entity 214. For example, exploded view 248 depicts that a total charge over a scheduled period for Acct. No. 123abc is $2000.00. Using billing device driver 233, entity accounting application 218 is accessed, and a charge back is facilitated. For example, entity accounting application 218 includes a data-center-using sub-entity financial report 250. Financial report 250 exemplifies that the total charge of $2000.00, which was generated by charge generator 232, is counted as an expense of sub-entity 214 and is subtracted from a budget of sub-entity 214. The financial data depicted in FIG. 2 is merely for illustrative purposes, and in other embodiments of the present invention, multiple charges might arise from multiple accounts of DC-using sub-entity 214 and multiple users under a single account. Multiple separate charges enable DC-using sub-entity 214 to track funding for individual projects and individual employees. In an alternative embodiment, all charges might be combined and presented in one bill.

In a further embodiment, data-center-managing sub-entity 216 is credited with “revenue” based on departmental charge backs of sub-entities that use data-center resources. For example, arrow 270 and financial report 252 depict sub-entity 216 being credited with $2000.00 based on the charge back from sub-entity 214. However, because internal charge backs are not “revenue” in the traditional accounting sense, steps are taken to accurately describe (i.e., code) internal charge backs. Moreover, Generally Accepted Accounting Principles (GAAP) suggest that money received from external sources should be reported separately from internal cost or expense transfers. Proper coding of internal charge backs helps to avoid improper taxation and compliance issues, such as those that might arise from Sarbanes-Oxley Act or other similar statutes. By taking steps to accurately code (i.e., label) charge backs, the entity accounting application 218 can be used for reporting purposes. For example, financial report 254 depicts a report that identifies the charge back from sub-entity 214 to sub-entity 216 as an internal cost transfer, as opposed to revenue or expenses from an external source.

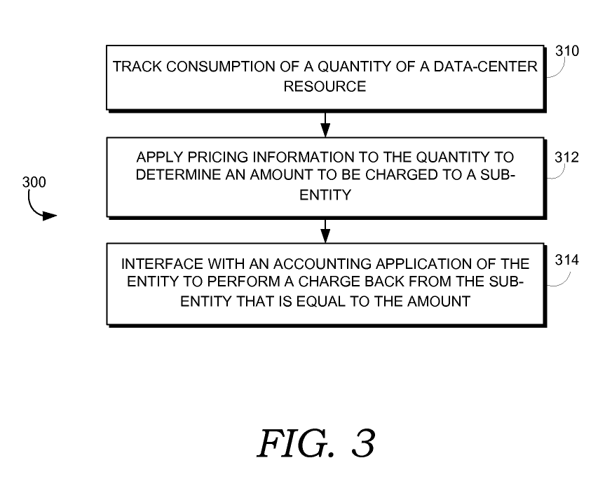

Referring now to FIG. 3, another exemplary embodiment of the present invention is depicted by a flow diagram and is identified generally by reference numeral 300. An embodiment of the present invention includes a method 300 of processing internal use of an entity's data center by a sub-entity of the entity. Method 300 includes at step 310 tracking a consumption of a quantity of a data-center resource, wherein the quantity of the data-center resource is consumed in order to execute a computing operation of the sub-entity. Step 312 includes applying a pricing model to the quantity to determine an amount to be charged to the sub-entity. Moreover, step 314 includes interfacing by a computing device with an accounting application of the entity to perform a charge back from the sub-entity that is equal to the amount, wherein the accounting application reports the amount as an internal cost transfer of the entity.

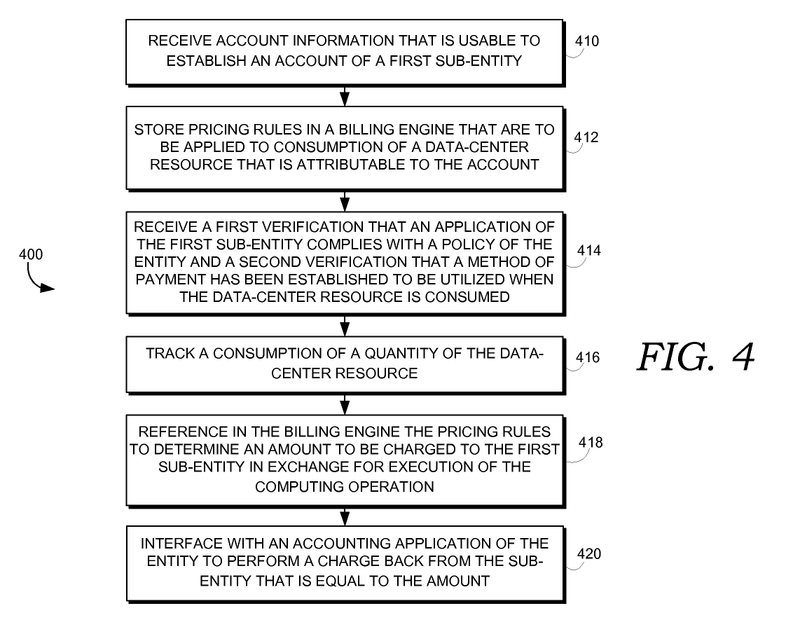

Referring now to FIG. 4, another exemplary embodiment of the present invention is depicted by a flow diagram and is identified generally by reference numeral 400. An embodiment of the present invention includes one or more computer-readable media having computer-executable instructions embodied thereon that, when executed by a computing device, cause the computing device to perform a method 400 of processing internal use of an entity's data center by a sub-entity of the entity. Method 400 includes step 410, which includes receiving account information that is usable to establish an account of a first sub-entity, wherein the account associates the first sub-entity with the data center. At step 412 pricing rules are stored in a billing engine that are to be applied to consumption of a data-center resource that is attributable to the account. Step 414 includes receiving a first verification that an application of the first sub-entity complies with a policy of the entity and a second verification that a method of payment has been established to be utilized when the data-center resource is consumed. Method 400 also includes at step 416, tracking a consumption of a quantity of the data-center resource, wherein the quantity of the data-center resource is consumed in order to execute a computing operation of the sub-entity. Pricing rules in the billing engine are referenced, at step 418, to determine an amount to be charged to the first sub-entity in exchange for execution of the application. Step 420 includes interfacing with an accounting application of the entity to perform a charge back from the first sub-entity that is equal to the amount. The charge back transfers the amount from the first sub-entity to a second sub-entity of the entity, and the accounting application reports the amount as an internal cost transfer of the entity.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of processing internal use of an entity's data center by a sub-entity of the entity, the method comprising:
tracking a consumption of a quantity of a data-center resource, wherein the quantity of the data-center resource is consumed in order to execute a computing operation of the sub-entity;
applying pricing information to the quantity to determine an amount to be charged to the sub-entity; and
interfacing by a computing device with an accounting application of the entity to perform a charge back from the sub-entity that is equal to the amount, wherein the accounting application reports the amount as an internal cost transfer of the entity.

2. The method of claim 1, wherein to execute a computing operation includes using a processor to execute a computer program of the sub-entity.

3. The method of claim 2, wherein the computer program includes a cloud application that leverages the data-center resource.

4. The method of claim 1, wherein to execute a computing operation includes communication between components of the entity's data center and wherein the data center resource includes consumed bandwidth.

5. The method of claim 1, wherein the data center facilitates cloud computing that is controlled by the entity.

6. The method of claim 5, wherein the cloud computing includes private-cloud computing that is only available to be used by the entity and sub-entities of the entity.

7. The method of claim 1, wherein pricing information includes internal-pricing options, which are available to be applied to consumption of data-center resources that is attributable to only sub-entities of the entity.

8. The method of claim 1, wherein pricing information includes a per-resource-consumed rate.

9. The method of claim 1, wherein pricing information includes a flat fee.

10. The method of claim 1, wherein the pricing information includes differential pricing of different geographic regions.

11. The method of claim 1, wherein interfacing comprises executing a billing device driver that is customized to enable communication with the accounting application.

12. The method of claim 1, wherein performing the charge back facilitates a transfer of the amount from the sub-entity to another sub-entity of the entity.

13. The method of claim 12, wherein the other sub-entity manages the data-center.

14. The method of claim 13, wherein the other sub-entity includes an information-technology department of the entity.

15. A system, which includes a server, a processor, and a computer-readable medium, for performing a method of processing internal use of an entity's data center by a sub-entity of the entity, the system comprising:
the computer-readable medium having stored thereon data of the sub-entity that facilitates a computing operation, wherein execution of the computing operation consumes a quantity of a data-center resource;
a resource-consumption tracker that measures the quantity of the data-center resource that is consumed by execution of the computing operation;
a charge generator that applies a pricing model to the quantity to determine an amount to be charged to the sub-entity; and
a billing device driver that interfaces with an accounting application of the entity to perform a charge back from the sub-entity that is equal to the amount.

16. The system of claim 15,
wherein the data is a private-cloud application, and
wherein the data center provides a private cloud that executes the private-cloud application.

17. The system of claim 15, wherein the billing device driver is customized to enable communication with the accounting application.

18. The system of claim 15 further comprising a plurality of billing device drivers, each of which enables communication with a respective accounting application of the entity.

19. The system of claim 15, wherein a data center that houses the data-center resource includes a modular data center that is pre-fabricated in a shipping container to include necessary components of a functional data center.

20. One or more computer-readable media having computer-executable instructions embodied thereon that, when executed by a computing device, cause the computing device to perform a method of processing internal use of an entity's data center by a sub-entity of the entity, the method comprising:
receiving account information that is usable to establish an account of a first sub-entity, wherein the account associates the first sub-entity with the data center;
storing pricing rules in a billing engine that are to be applied to consumption of a data-center resource that is attributable to the account;
receiving a first verification that an application of the first sub-entity complies with a policy of the entity and a second verification that a method of payment has been established to be utilized when the data-center resource is consumed;
tracking a consumption of a quantity of the data-center resource, wherein the quantity of the data-center resource is consumed in order to execute a computing operation of the first sub-entity;
referencing in the billing engine the pricing rules to determine an amount to be charged to the first sub-entity in exchange for execution of the computing operation; and
interfacing with an accounting application of the entity to perform a charge back from the first sub-entity that is equal to the amount,
wherein the charge back transfers the amount from the first sub-entity to a second sub-entity of the entity, and
wherein the accounting application reports the amount as an internal cost transfer of the entity.
